(19) United States
(12) Patent Application Publication
(10) Pub. No.: US 2024/0228169 A1
(43) Pub. Date: Jul. 11, 2024

(54) AUTONOMOUS PIVOT WHEEL ASSEMBLY FOR PACKAGE HANDLING

(71) Applicant: James R Moore II, Louisville, KY (US)

(72) Inventor: James R Moore II, Louisville, KY (US)

(21) Appl. No.: 17/971,609

(22) Filed: Dec. 8, 2022

(51) Int. Cl. B65G 13/06; B65G 43/00

(52) U.S. Cl. CPC B65G 13/06; B65G 43/00

(57) ABSTRACT

A package handling diverter, merge and sorter for package sortation is disclosed. The system includes at least one base frame with individual, cellular and autonomous pivot wheels mounted to the frame, in plurality, and can be combined together to form a complete sortation system. Each autonomous pivot wheel is a cellular design possessing its own drive motors so each can perform autonomously, yet in concert with other autonomous pivot wheels. The system is cable of diverting, merging and sorting packages. The autonomous pivot wheels are interactively coupled for communication therebetween whereby packages are selectively moved about configurable paths.

### BACKGROUND OF THE INVENTION

The system described herein relates generally to an apparatus and method for arranging packages being processed on a conveyor system or the like. The present embodiments more specifically include a novel apparatus employing a plurality of robotic assemblies for diverting; merging, splitting, sorting, orienting and conveying packages with no manual user input.

In conventional package conveying systems utilized in e-commerce applications packages being conveyed usually need to be sorted by one of many criteria, often by destination addresses for example, or any one of many different shipping criteria. These prior art systems frequently use some type of vision system or reader to examine each package's label, thereby providing a wide variety of package information to an automated control system used to sort and direct packages to a customer or other end user. Package labels and/or bar codes can provide information including, but not limited to customer names, addresses, transportation information, billing information and delivery options. However, once the sorting information for each package is known the packages must then be directed or diverted to branching conveyor systems or end destination storage for further processing, for example loading on a truck or aircraft for delivery to another location.

Some prior art systems simply use manual labor to sort and divert packages, which are simply positioned by hand as the packages are being conveyed. Obviously these systems require constant human attention and are prone to slow-downs and errors when multiple mis-oriented packages require repositioning in a short span of time. Some systems utilize a variety of different systems such as mechanical diverters or even package handling robots to divert and reorient packages, but these systems are often slow and prone to mechanical issues, again requiring human input to repair or correct.

Accordingly, one disadvantage with prior art package sorting systems is the ability to provide high throughput sorting in an automated system. Another disadvantage of prior art systems is their relative inability to accept and sort a plurality of packages from multiple flow streams such as a plurality of converging conveyor systems. Additionally, many prior art systems are incapable of orienting and diverting packages on the fly, or while moving.

Accordingly, there is a need for an automated package conveying system that overcomes the many disadvantages of the prior art.

### SUMMARY OF THE INVENTION

In various aspects and embodiments the system described herein provides a novel conveying system employing a plurality of autonomous pivot wheel assemblies systems to sort and arrange a moving package stream. A wide variety of embodiments and uses may be employed implementing the apparatus and system utilizing a variety of structures without departing from the teachings of this specification.

In some aspects and embodiments the autonomous pivot wheel system includes a plurality of pivot roller assemblies to simultaneously move and orient packages through a packaging conveyor system. A plurality of autonomous pivot wheels may be disposed at various locations around a sorting table or area of a conveyor without departing from the scope of the embodiments disclosed.

In various embodiments and aspects system disclosed herein utilizes a plurality of pivot roller assemblies disposed on a conveyor surface that are each electrically operated via computer control such that each pivot roller is individually controllable. Furthermore, each pivot roller is capable of rotation around a 360 degree vertical axis so an assembly, or a group of assemblies, can be oriented to direct a package in any direction along the conveyor surface, responsive to a computer input representative of a desired package direction.

As used herein for purposes of the present disclosure, the term “pivot roller” can be used to refer to any automated, computer controlled wheel that can be disposed or mounted on a conveyor surface, and that can be oriented in a plurality of directions for conveying, orienting a moving package of a predetermined size. Any of a wide variety of pivot rollers may be utilized with the concepts and embodiments of the invention as taught herein without limiting the scope of the claims appended hereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other advantages and features, which characterize the embodiments, are set forth in the claims appended hereto and form a further part thereof. However, for a better understanding of the embodiments and of the advantages and objectives attained through their use, reference should be made to the Drawing Figures and to the accompanying specification, in which there are described exemplary embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWING FIGURES

In the drawings, like reference characters generally refer to the same parts throughout the different views. Also, the drawings are not necessarily to scale, emphasis instead generally being placed upon illustrating the principles of the various embodiments.

FIG. 1 is a perspective view of an autonomous pivot wheel in accordance with various embodiments;

FIG. 2 is a side view of an autonomous pivot wheel in accordance with various embodiments;

FIG. 3 is a top view of an autonomous pivot wheel in accordance with various embodiments;

FIG. 4 is a side view of an autonomous pivot wheel in accordance with various embodiments;

FIG. 5 is a view of an autonomous pivot wheel taken along the line A-A of FIG. 4 in accordance with various embodiments;

FIG. 6 is a perspective view of a group of autonomous pivot wheels mounted in a conveyor rack in accordance with various embodiments;

FIG. 7 is a top view of a group of autonomous pivot wheels mounted in a conveyor rack in accordance with various embodiments;

FIG. 8 is a side view of a group of autonomous pivot wheels mounted in a conveyor rack in accordance with various embodiments;

FIG. 9 is a side view of a pivot wheel in accordance with various embodiments;

FIG. 10 is a view of a pivot wheel taken along the line A-A of FIG. 9 in accordance with various embodiments; and

FIG. 11 is a detail view of a pivot wheel shown in area C of FIG. 10.

### DETAILED DESCRIPTION OF THE PREFERRED EMBODIMENT(S)

Numerous variations and modifications of the apparatuses and embodiments of the disclosed invention will be apparent to one of ordinary skill in the art, as will be readily seen from the detailed description of the system set forth below. Therefore, the invention is not limited to the specific implementations discussed herein.

Furthermore, the embodiments discussed herein will focus on the implementation of the described techniques and apparatuses for a robotic system for sorting and culling packages. While the embodiments described herein will refer generally to implementation of a robotic package sorting and culling system one of ordinary skill will recognize that the invention may be practiced with a broad array of automated, mechanically controlled structures and components without departing from the scope thereof.

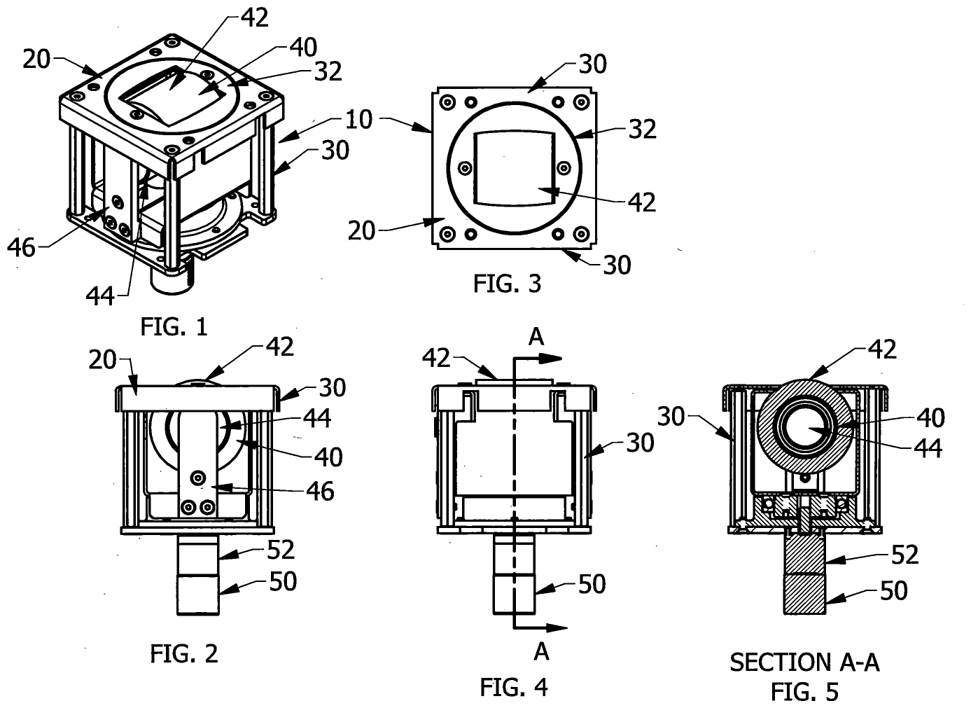

Referring now to drawing FIGS. 1-2 and in accordance with various aspects and embodiments, herein is described a novel autonomous pivot wheel system for sorting, conveying, diverting, and orienting packages. One of ordinary skill in the art will recognize that a wide variety of components and structures may be employed in conjunction with the embodiments without departing from the scope thereof. For example, the embodiments described herein are capable of being employed and/or adapted for use in a conventional package conveyor, as depicted in FIG. 1. However, many other embodiments and uses may be employed implementing the apparatus and system utilizing a variety of structures without departing from the teachings of this specification.

The autonomous pivot wheel system 10 embodiments disclosed herein are suited for use with a package conveyor, or a plurality thereof, and in some embodiments forms a portion of the surface of a conveyor or conveyors. As seen in FIG. 1 an autonomous pivot wheel assembly 20 includes a frame 30 that generally encloses and protects the various components of assembly 20 as well as a enable quick change-out of a damaged pivot wheel assembly 20. Frame 30 has an open top portion 32 that through which a rotating roller 40 extends so that the top surface of the roller is slightly above the surface of frame 30 opening 32. Roller 40 has an exterior surface 42 that contacts a package being conveyed, and further includes a brushless direct current (DC) motor 44 that drives roller 40 and is journaled for rotation in a roller frame assembly 46. Frame assembly 46 is also capable of independent rotation around a vertical axis, as will be discussed herein. In some embodiments roller 40, driven by motor 44 is capable of rotation at variable rates of speed depending upon package conveying requirements. In some aspects roller 40 may operate at a rate sufficient to convey packages at 700 feet per minute, far in excess of many prior art conveyors.

It should be noted that roller motor 44 as well as all electrical controls of pivot wheel system 10 may be advantageously controlled by a processor having concomitant memory and operable inputs and outputs (not shown) that executes an instruction set to actuate and control the various electrical elements set forth herein.

Referring again to FIGS. 1-6 in various embodiments pivot wheel assembly 20 also includes a pivot 50, operatively coupled to a controller. Pivot 50 also includes a brushless DC motor 52 and is rotatable by operation of motor 52 around a vertical axis. Pivot 50 is secured to Roller 40 frame 46 such that pivot 50 is capable of rotating frame 46 and thus roller 40 fully 360 degrees. In some embodiments and similar to roller 40 pivot 50 is operatively coupled to a controller output such that pivot 50 can accurately and quickly orient roller 50 in a particular drive direction. Accordingly, pivot wheel assembly 20 may advantageously be rotated to any directional orientation, and then driven at any speed by automated operation.

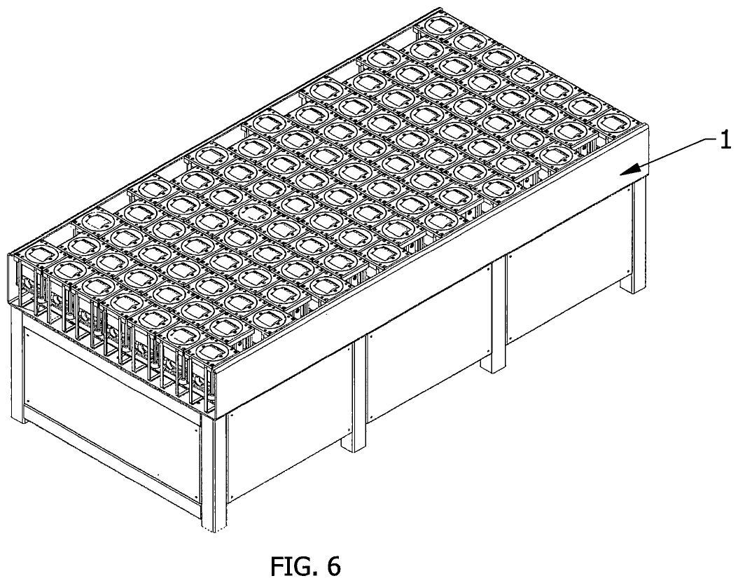

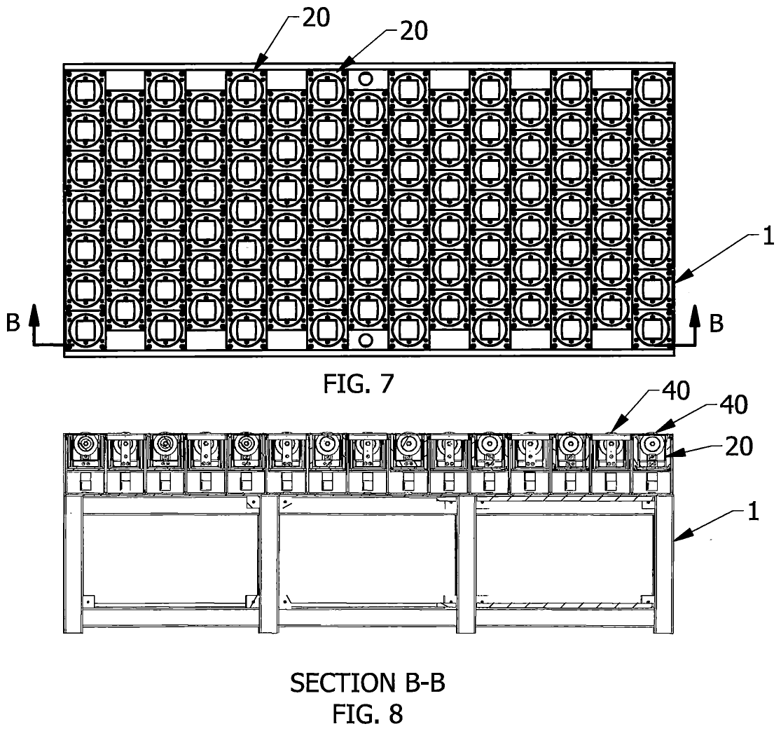

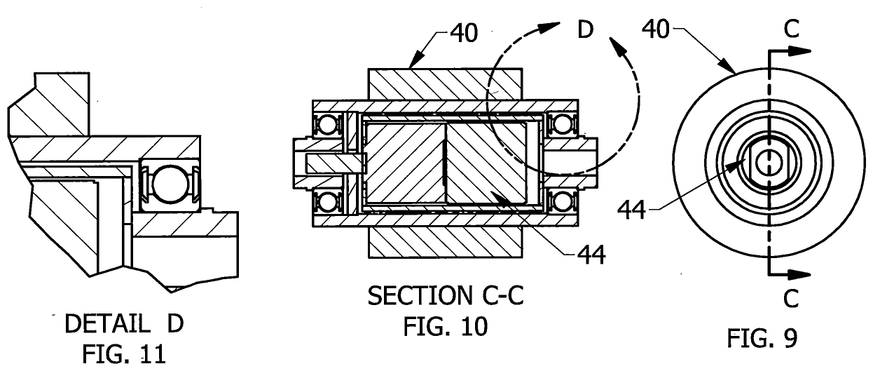

In some aspects and embodiments and as best seen in FIGS. 6-8, a plurality of pivot wheel assemblies 20 can be arranged on a conveyor table to form a sorting and orienting conveyor 1. Each assembly 20 can be individually controlled as discussed herein above, and furthermore groups of pivot wheel assemblies 20 can be operated together to achieve a desired package path and orientation. For example, a package that needs to exit the conveyor at a second end on the left side may enter conveyor 1 at a first end on the right side and then be driven diagonally across the conveyor 1 by a plurality of rollers 40 oriented to provide diagonal motion. Similarly, as can be readily seen, where a specific package has been identified to on a side of conveyor 1, or even be turned around or reoriented, pivot wheel assemblies 20 can simply be operated via processor outputs to provide the required package direction and motion.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The system described herein is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

While the present system has been shown and described herein in what are considered to be the preferred embodiments thereof, illustrating the results and advantages over the prior art obtained through the present system, the system is not limited to those specific embodiments. Thus, the forms of the system shown and described herein are to be taken as illustrative only and other embodiments may be selected without departing from the scope of the thereof, as set forth in the claims appended hereto.

I claim:

1. An autonomous pivot wheel assembly system for use with a conveyor having first and second ends comprising:
a frame housing a roller capable of rotation around a generally horizontal axis, said roller driven by a direct current brushless motor;
a roller frame capable of rotation within said frame; and
a pivot secured to said roller frame and capable of rotation thereby rotating said roller frame, said pivot driven by a direct current brushless motor.

2. The apparatus of claim 1 comprising a plurality of autonomous pivot wheels controlled independently.

3. The apparatus of claim 1 comprising:
a controller having a processor and data memory, said controller having a plurality of inputs and outputs for operating said pivot wheel assembly.

4. The apparatus of claim 3 wherein said brushless dc motors of said plurality of autonomous pivot wheels are controlled independently responsive to an instruction set stored in said controller data memory.

5. The apparatus of claim 4 wherein said autonomous pivot wheel assemblies are controlled responsive to package routing criteria.
